(19) United States
(12) Patent Application Publication
(10) Pub. No.: US 2026/0201179 A1
(43) Pub. Date: Jul. 16, 2026

(54) SUBSTRATE CLEANING COMPOSITION, AND USING THE SAME, METHOD FOR MANUFACTURING CLEANED SUBSTRATE AND METHOD FOR MANUFACTURING DEVICE

(71) Applicant: Merck Patent GmbH, Darmstadt (DE)

(72) Inventors: Takafumi Kinuta, Shizuoka (JP); Tatsuro Nagahara, Shizuoka (JP)

(21) Appl. No.: 19/137,218

(22) PCT Filed: Dec. 15, 2023
(86) PCT No.: PCT/EP2023/085994

§ 371 Date: Jun. 9, 2025

(30) Foreign Application Priority Data
Dec. 19, 2022 (JP) 2022-202433

(51) Int. Cl. C09D 5/20; C09D 133/02

(52) U.S. Cl. CPC C09D 5/20; C09D 133/02

(57) ABSTRACT

To obtain a substrate cleaning composition capable of cleaning a substrate and removing particles. [Means for Solution] To provide a substrate cleaning composition comprising an insoluble or hardly soluble solute (A), wherein the insoluble or hardly soluble solute (A) is a monomer of (A-1) and/or a multimer of (A-1); the pKa of the insoluble or hardly soluble solute (A) is 9.5 to 4, the pKb of the insoluble or hardly soluble solute (A) is 9.5 to 4, and/or (A-1) comprises 2 to 4 polar groups; and the polar group is at least one selected from the group consisting of −OH, —COOH, —NO₂, —NH₂ and —NH—.

### BACKGROUND OF THE INVENTION

### Technical Field

The present invention relates to a substrate cleaning composition, and using the same, a method for manufacturing a cleaned substrate and a method for manufacturing a device.

### Background Art

Conventionally, in the process of manufacturing a substrate, debris may be generated, for example, by a lithography process or the like. Therefore, the substrate manufacturing step may include a cleaning step for removing particles on the substrate. In the cleaning step, there are methods such as a method for physically removing particles by supplying a cleaning liquid such as deionized water (DIW: deionized water) on the substrate and a method for chemically removing particles with chemicals. However, as patterns become finer and more complicated, they become more susceptible to physical or chemical damage.

As a substrate cleaning step, a method of forming a film to hold particles in the film and removing the film by a remover has been studied. When the formed film is all dissolved by the remover, the particles held in the film can be reattached. Therefore, a method of partially dissolving the formed film and removing the undissolved part in a solid state has been studied. In Patent Documents 1 and 2, a study for forming a film using a cleaning liquid containing a hardly soluble or insoluble solute, a soluble solute and water, and then removing the film is performed.

### PRIOR ART DOCUMENTS

### Patent Documents

[Patent document 1] WO 2020/120667
[Patent document 2] WO 2021/245014

### SUMMARY OF THE INVENTION

### Problems to be Solved by the Invention

The present inventors considered that in the technology of forming a film on a substrate to remove particles, there are one or more problems still need improvements. They include, for example, the followings: removal of particles is not effective; the remover used for the formed film is an alkaline aqueous solution; films formed is difficult to be fully removed by a remover and remain; organic solvents are used for cleaning after removal with a remover; efficient removal is not possible for both hydrophobic and hydrophilic substrates.

The present invention has been made based on the technical background as described above and provides a substrate cleaning composition.

### Means for Solving the Problems

The substrate cleaning composition according to the present invention comprises an insoluble or hardly soluble solute (A):

wherein
the insoluble or hardly soluble solute (A) is a monomer of (A-1) and/or a multimer of (A-1);
the pKa of the insoluble or hardly soluble solute (A) is 9.5 to 4, the pKb of the insoluble or hardly soluble solute (A) is 9.5 to 4, and/or (A-1) comprises 2 to 4 polar groups; and
the polar group is at least one selected from the group consisting of —OH, —COOH, —NO₂, —NH₂ and —NH—.

The method for manufacturing a cleaned substrate according to the present invention comprises the following steps:
(1) applying the above-mentioned substrate cleaning composition on a substrate;
(2) forming a film from the substrate cleaning composition;
(3) making the film hold particles on the substrate; and
(4) applying a remover on the substrate to remove the film in which particles are held.

The method for manufacturing a device according to the present invention comprises the method for manufacturing the above-mentioned cleaned substrate.

### Effects of the Invention

Using the substrate cleaning composition according to the present invention, it is possible to desire one or more of the following effects.

It is possible to effectively remove particles; using water as the remover for the formed film, it is possible to sufficiently peel off the film and remove it from the substrate; it is possible to efficiently remove the film using an alkaline aqueous solution as a cleaning liquid after removal of the remover; it is possible to efficiently remove the particles from both hydrophobic and hydrophilic substrates; it is possible to strengthen the force of drawing the remover to the interface between the film containing the component (A) and the substrate.

### BRIEF DESCRIPTION OF THE DRAWINGS

FIG. 1 is a cross section that schematically illustrates the appearance of a substrate surface in the substrate cleaning according to the present invention.

### DETAILED DESCRIPTION OF THE INVENTION

### Mode for Carrying Out the Invention

The embodiments of the present invention are described below in detail.

### Definition

Unless otherwise specified, the definitions and examples described in this paragraph are followed.

The singular form includes the plural form and “one” or “that” means “at least one”. An element of a concept can be expressed by a plurality of species, and when the amount (for example, mass % or mol %) is described, it means sum of the plurality of species.

“And/or” includes a combination of all elements and also includes single use of the element.

When a numerical range is indicated using “to” or “-”, it includes both endpoints and units thereof are common. For example, 5 to 25 mol % means 5 mol % or more and 25 mol % or less.

The descriptions such as “C_{x-y}”, “Cₓ-C_{y}” and “Cₓ” mean the number of carbons in a molecule or substituent. For example, C₁₋₆ alkyl means an alkyl chain having 1 or more and 6 or less carbons (methyl, ethyl, propyl, butyl, pentyl, hexyl etc.).

When polymer has a plural types of repeating units, these repeating units copolymerize. These copolymerization may be any of alternating copolymerization, random copolymerization, block copolymerization, graft copolymerization, or a mixture thereof. When polymer or resin is represented by a structural formula, n, m or the like that is attached next to parentheses indicate the number of repetitions.

Celsius is used as the temperature unit. For example, 20 degrees means 20 degrees Celsius.

The additive refers to a compound itself having a function thereof (for example, in the case of a base generator, the compound itself that generates a base). An aspect in which the compound is dissolved or dispersed in a solvent and added to the composition is also possible. As one embodiment of the present invention, it is preferable that such a solvent is contained in the composition according to the present invention as the solvent (C) or another component.

### <Substrate Cleaning Composition>

The substrate cleaning composition according to the present invention comprises an insoluble or hardly soluble solute (A) (hereinafter sometimes referred to as the component (A) or the solute (A), and the same applies to (B) and the following). Here, the solute (A) is a monomer of (A-1) and/or a multimer of (A-1), and the pKa of the insoluble or hardly soluble solute (A) is 9.5 to 4, or the pKb of the insoluble or hardly soluble solute (A) is 9.5 to 4, and/or (A-1) comprises 2 to 4 polar groups and the polar group is at least one selected from the group consisting of —OH, —COOH, —NO₂, —NH₂ and —NH—.

Preferably, the insoluble or hardly soluble solute (A) is insoluble or hardly soluble by the remover (more preferably hardly soluble). Preferably, the soluble solute (B) is soluble by the remover.

The substrate cleaning composition according to the present invention can comprise a solvent (C).

In the present invention, the “solute” is not limited to the state of being dissolved in the solvent (C), and a suspended state thereof or a solid state without containing the solvent (C) is also accepted.

In a preferred embodiment, the solutes, components and additives contained in the substrate cleaning composition are soluble in the solvent (C). It can be thought that the substrate cleaning composition in this embodiment has good embedding properties or film uniformity.

In a preferred embodiment, the substrate cleaning composition according to the present invention is applied on a substrate and dried to remove at least a part of the solvent (C) to form a film, and then the film is removed from the substrate by a remover.

In another preferred embodiment, the substrate cleaning composition according to the present invention is applied on a substrate and heated to form a film, and then the film is removed from the substrate by a remover.

“To form a film” means a state in which a continuous film is formed on a substrate. When a solidified component other than the solute (A) (for example, the solute (B)) is contained, a state in which one film is formed and the solidified components coexist in one film is preferred. One embodiment of the film formation is the “solidification” of solutes. Additionally, the film obtained from the substrate cleaning composition only needs to have a hardness to the extent to hold particles, and the solvent (C) is contained, the solvent (C) is not completely removed (for example, through vaporization). In one preferred embodiment, the substrate cleaning composition gradually shrinks to form a film as the solvent (C) is vaporized.

It is accepted that an extremely small amount of the insoluble or hardly soluble solute (A) and other components contained as necessary is removed (for example, vaporization, volatilization). For example, it is accepted that 0 to 10 mass % (preferably 0 to 5 mass %; more preferably 0 to 3 mass %; further preferably 0 to 1 mass %; further more preferably 0 to 0.5 mass %) relative to the original amount is removed.

Although there is no intention to limit the scope of the invention and not to be bound by theory, it is thought that particles are removed by being held in the film on the substrate and being peeled off by a remover that is described later. When the soluble solute (B) is contained, it can be thought that this creates a part that triggers the film to be peeled off, and it can be thought that more efficient peeling can be achieved.

### <Insoluble or Hardly Soluble Solute (A)>

The substrate cleaning composition according to the present invention comprises an insoluble or hardly soluble solute (A).

The component (A) is a monomer of (A-1) and/or a multimer of (A-1), and can be a mixture of a monomer and a multimer. Preferably, the component (A) is a multimer of (A-1).

The component (A) satisfies at least one of the following (i) to (iii), preferably satisfies (iii), and more preferably satisfies (i) and (iii).

Preferably, the component (A) does not satisfy (i) and (ii) simultaneously.
(i) pKa is 9.5 to 4;
(ii) pKb is 9.5 to 4; and
(iii) (A-1) preferably comprises 2 to 4 polar groups. The polar groups are selected from at least one of the group consisting of —OH, —COOH, —NO₂, —NH₂ and —NH—, and each polar group can be identical or different, and for example, contains —OH and —COOH.

When the substrate cleaning composition according to the present invention is used, the component (A) forms a film to hold particles, which can then be easily removed with water.

Preferably, (A-1) is represented by the formula (a-1):

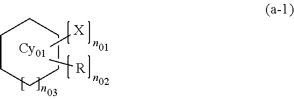

where
Cy₀₁ is an unsaturated hydrocarbon ring, preferably a 5-membered ring or a 6-membered ring, more preferably a 6-membered ring (n₀₃ is 1), and 1 to 3 of the C constituting Cy₀₁ can be each independently replaced with N, S or O (more preferably unsubstituted). Cy₀₁ is preferably cyclopentane, cyclohexane, benzene, pyridine, diazine or triazine (more preferably benzene or triazine; further preferably benzene). Cy₀₁ is preferably an aromatic ring (more preferably an aromatic hydrocarbon ring or an aromatic heterocycle; further preferably an aromatic hydrocarbon ring);
X is each independently —OH, —COOH, —NO₂ or —NR′R″, preferably —OH, —COOH or —NH₂, more preferably —OH or —NH₂;
R′ and R″ are each independently hydrogen or C₁₋₅ alkyl, preferably hydrogen, methyl, ethyl, n-propyl, n-butyl or cyclopropyl;
R is each independently C₁₋₁₀ alkyl, —CHO, —C(═O)CH₃, —C(═O)C₂H₅, —CH═CH₂ or —O—C(═O)—CH═CH₂, preferably C₁₋₃ alkyl or —OC(═O)—CH═CH₂, more preferably —OC(═O)—CH═CH₂;
n₀₁ is 0 to 4, preferably 2 to 4, more preferably 2 to 3, further preferably 3;
n₀₂ is 0 to 3, preferably 0 or 1, more preferably 0, and when the component (A) is a multimer of (A-1), it is also preferable that n₀₂ is 1;
n₀₃ is 0 to 1, preferably 1; and
0≤(n₀₁+n₀₂)≤(5+n₀₃) is satisfied.

When the component (A) is a monomer of (A-1), examples thereof include phloroglucinol, benzenetriol, melamine, phloroglucinol carboxaldehyde, 2-acetylphloroglucinol, flopropione, 2,4,6-triformylphloroglucinol, N,N-dimethylmelamine, N,N-diethylmelamine, N-butylmelamine and cyromazine.

Preferably, the monomer of (A-1) excludes embodiments in which the same unit is repeatedly bonded two or more times.

When the component (A) is a multimer of (A-1), examples thereof include a multimer obtained by addition condensation of a monomer of (A-1) with formaldehyde, etc. and a multimer obtained by addition polymerization of C═C double bonds which a monomer of (A-1) has.

Preferably, the multimer of (A-1) is one in which the same unit is repeatedly bonded two or more times.

The multimer of (A-1) preferably comprises a repeating unit represented by the formula (a-1-1) or a repeating unit represented by the formula (a-1-2). More preferably, the multimer of (A-1) comprises a repeating unit represented by the formula (a-1-1).

The formula (a-1-1) is as follows:

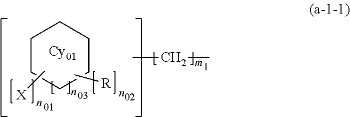

where
Cy₀₁, X, R, n₀₁, n₀₂ and n₀₃ are as described above;
m₁ is a number of 1 or more, preferably 1 to 3 (more preferably 1 to 2; further preferably 1 or 2; further more preferably 1); and
in the formula (a-1-1), the hydrogen atom in X or the hydrogen atom directly connected to the ring is removed and connected to —CH₂—, and as an example, there is an embodiment in which X is —NH₂ and this hydrogen atom is removed to become —NH—, which is bonded to methylene.

In a preferred embodiment, the formula (a-1-1) is represented by the formula (a-1-1α) or the formula (a-1-1β). More preferably, the formula (a-1-1) is represented by the formula (a-1-1α).

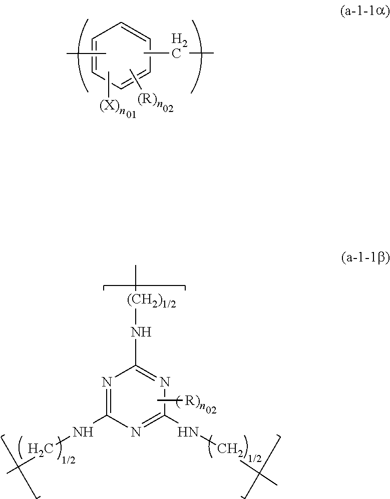

The symbols in the formulas have the same meanings as described above.

Examples of the repeating unit represented by the formula (a-1-1) include the following:

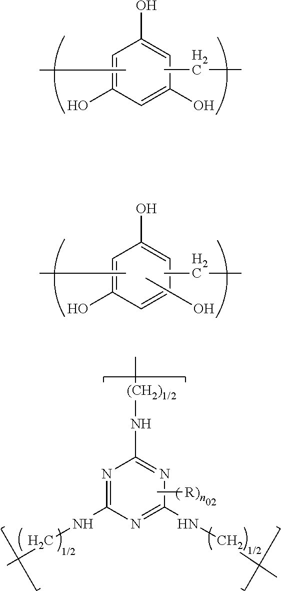

The formula (a-1-2) is as follows:

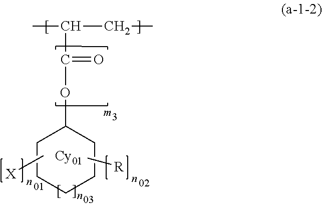

where
Cy₀₁, X, R, n₀₁, n₀₂ and n₀₃ are as described above; and
m₃ is 0 to 1, preferably 0 or 1 (more preferably 0).

Examples of the repeating unit represented by the formula (a-1-2) include the following.

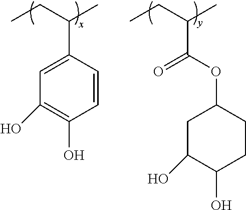

The multimer of (A-1) can comprise a repeating unit represented by a structure other than the formula (a-1-1) or the formula (a-1-2). Its ratio is preferably 5% or less, more preferably 1% or less, based on the total number of repeating units contained in (A-1).

The total number of repeating units contained in the multimer of (A-1), the number of repeating units having the structure of the formula (a-1-1) contained in the multimer of (A-1), and the number of repeating units having the structure of the formula (a-1-2) contained in the multimer of (A-1) are respectively taken as N_{(A-1)}, N₍ₐ₋₁₋₁₎, and N₍ₐ₋₁₋₂₎.

Preferably, {N₍ₐ₋₁₋₁₎+N₍ₐ₋₁₋₂₎}/N_{(A-1)}=40 to 100% (more preferably 70 to 100%; further preferably 90 to 100%; further more preferably 95 to 100%). In one preferred embodiment, the multimer of (A-1) does not contain any structure other than the formula (a-1-1) or the formula (a-1-2). The multimer of (A-1) can be terminally modified with H, methyl or OH. At the ends of the multimers (a-1-1α) and (a-1-1β), the methylene described in the repeating unit can be replaced with H.

Exemplified embodiments of the multimer of (A-1) include preferably phloroglucinol resin, benzenetriol resin, melamine resin or any combination of any of these (more preferably phloroglucinol resin or melamine resin).

The molecular weight (in the case of a polymer, the mass average molecular weight Mw) of the component (A) is preferably 100 to 50,000. When the component (A) is a multimer of (A-1), its Mw is preferably 250 to 10,000, more preferably 250 to 5,000, and further preferably 250 to 1,500. Here, the mass average molecular weight is a mass average molecular weight in terms of polystyrene, which can be measured by gel permeation chromatography based on polystyrene. The same applies to the following.

When the component (A) is a monomer of (A-1), its molecular weight is preferably 100 to 200 (more preferably 100 to 150; further preferably 100 to 130).

The content of the component (A) is preferably 1.0 to 100 mass %, preferably 1.0 to 50 mass %, more preferably 1.0 to 20 mass %, based on the substrate cleaning composition.

The solubility can be evaluated by a known method. For example, the solubility can be determined under the conditions of 20 to 35° C. (more preferably 25±2° C.) by providing a flask charged with 3,000 ppm of the component (A) or the component (B) in water, covering the flask with a cap, shaking for 1 hour in a shaker, and confirming whether the component (A) or the component (B) is dissolved or not. Shaking can be performed by stirring. Dissolution can also be determined visually. If not dissolved, the solubility is taken as 3,000 ppm or less, and if dissolved, the solubility is taken as more than 3,000 ppm. In the present specification, the solubility of 3,000 ppm or less is taken as insoluble or poorly soluble, and the solubility of more than 3,000 ppm is taken as soluble. Further, the solubility of 100 ppm or less is taken as insoluble. In the present specification, the solubility becomes higher in the order of insoluble, hardly soluble and soluble.

Preferably, the solubility of the component (A) in water is 3,000 ppm or less, and the solubility of the component (B) in water is preferably more than 3,000 ppm. The water used for solubility evaluation is preferably DIW.

The component (A) is insoluble or hardly soluble, but is preferably hardly soluble.

The water that is used in the solubility evaluation can be changed to another remover (described later) that is used in the subsequent process. For example, to determine whether a substance is insoluble, hardly soluble, or soluble in the remover, it is preferable to change the water that is used in the above-mentioned solubility evaluation to the remover.

### <Soluble Solute (B)>

The substrate cleaning composition according to the present invention can further comprise a soluble solute (B). The component (B) is preferably soluble in a remover.

The component (B) is preferably a substance comprising carboxy, sulfo or phospho; more preferably a substance comprising carboxy or phospho; further preferably a substance comprising carboxy.

The acid dissociation constant pKa (H₂O) of the component (B) is preferably −5 to 11; more preferably −1 to 8; further preferably 1 to 7; further more preferably 2 to 6.

In one preferred embodiment of the present invention, the component (B) present in the film formed from the substrate cleaning composition is dissolved out by the remover, thereby providing a trigger for the film to be peeled off. The solute (B) is preferably a crack-promoting component (B′), and the crack-promoting component (B′) preferably comprises a carboxy-containing hydrocarbon.

When the substrate cleaning composition according to the present invention comprises the component (B), although not to be bound by theory, it can be thought that when the substrate cleaning composition forms a film on the substrate and the remover peels off the film, the component (B) creates a part that triggers the film to be peeled off. For this reason, it is preferable that the component (B) has higher solubility in the remover than the component (A).

The component (B) preferably comprises a repeating unit represented by the formula (b-1):

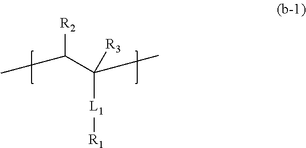

where
L₁ is selected from the group consisting of a single bond, C₁₋₄ alkylene, phenylene, ether, carbonyl, amide and imide; preferably selected from the group consisting of a single bond, methylene, ethylene, phenylene and amide; more preferably a single bond and phenylene; further more preferably a single bond;
when L₁ is amide or imide, H present at a part other than that connecting R₁ and the main chain can or cannot be substituted with methyl; more preferably, it is unsubstituted;
R₁ is carboxy, sulfo or phospho; preferably carboxy or sulfo; more preferably carboxy;
R₂ is hydrogen, methyl or carboxyl; preferably hydrogen or carboxyl; more preferably hydrogen; and
R₃ is hydrogen or methyl; preferably hydrogen.

The component (B) is preferably a polymer comprising a structural unit represented by the formula (b-1). Preferred examples of the polymer comprising the structural unit represented by the formula (b-1) include polyacrylic acid, polymaleic acid, polystyrene sulfonic acid or a polymer combining these. Polyacrylic acid and maleic acrylic acid copolymers are further preferred examples.

In the case of copolymerization, random copolymerization or block copolymerization is preferred, and random copolymerization is more preferred.

As an example, the following maleic acid acrylic acid copolymer is cited and explained. This has two types of repeating units represented by (b-1).

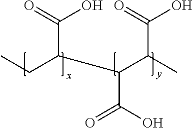

The molecular weight (in the case of a polymer, the mass average molecular weight Mw) of the component (B) is preferably 500 to 500,000; preferably 1,000 to 100,000; more preferably 2,000 to 50 000, further preferably 5,000 to 50,000; further more preferably 5,000 to 40,000.

The soluble solute (B) can be obtained even by either synthesizing or purchasing. As a supplier, Sigma-Aldrich, Tokyo Chemical Industry Co., Ltd. and Nippon Shokubai Co., Ltd. are mentioned.

The content of the component (B) is preferably 0 to 50 mass %; more preferably 1 to 50 mass %; further preferably 1 to 30 mass %; further more preferably 1 to 10 mass %, based on the substrate cleaning composition.

### <Solvent (C)>

The substrate cleaning composition according to the present invention can further comprise a solvent (C).

In one embodiment of the present invention, the solvent (C) can comprise water (C-1). Water (C-1) is preferably deionized water (DIW). When water (C-1) is contained, a part thereof may be removed during the film formation, but at least a part thereof remains in the film after the film formation.

Although not to be bound by theory, it can be thought that due to the presence of water (C-1) in the film, penetration of the remover into the film is promoted and more efficient removal of the film becomes possible.

The content of water (C-1) is preferably 0.1 to 10 mass %; more preferably 0.01 to 20 mass %; further preferably 0.05 to 20 mass %, based on the solvent (C).

It is also a preferred embodiment of the present invention that water (C-1) is not contained (0 mass %).

Preferably, the solvent (C) comprises an organic solvent (C-2).

Preferably, the organic solvent (C-2) has volatility. In the present invention, having volatility means to have higher volatility compared with water. For example, the boiling point of the organic solvent (C-2) at one atmospheric pressure is preferably 50 to 250° C., more preferably 50 to 200° C., further preferably 60 to 170° C., and further more preferably 70 to 150° C.

The organic solvent (C-2) includes alcohols such as isopropanol (IPA); ethylene glycol monoalkyl ethers such as ethylene glycol monomethyl ether and ethylene glycol monoethyl ether; ethylene glycol mono alkyl ether acetates such as ethylene glycol monomethyl ether acetate and ethylene glycol monoethyl ether acetate; propylene glycol monoalkyl ethers such as propylene glycol monomethyl ether (PGME), propylene glycol monoethyl ether (PGEE); propylene glycol monoalkyl ether acetates such as propylene glycol monomethyl ether acetate (PGMEA) and propylene glycol monoethyl ether acetate; lactic acid esters such as methyl lactate and ethyl lactate (EL); aromatic hydrocarbons such as toluene and xylene; ketones such as methyl ethyl ketone, 2-heptanone and cyclohexanone; amides such as N,N-dimethylacetamide and N-methyl pyrrolidone; and lactones such as y-butyrolactone. These organic solvents can be used alone or in any combination of any two or more of these.

In a preferred embodiment, the organic solvent (C-2) is selected from IPA, PGME, PGEE, EL, PGMEA, and any combination of any of these. When the organic solvent is a combination of two, the volume ratio is preferably 20:80 to 80:20, and more preferably 30:70 to 70:30.

The solubility of the organic solvent (C-2) in water is preferably 10 g/100 g H₂O or more, more preferably 20 g/100 g H₂O or more, further preferably 25 to 1,000 g/100 g H₂O, and further more preferably 50 to 200 g/100 g H₂O. The measurement of the solubility in water is preferably carried out at normal temperature and normal pressure, where normal temperature is 20 to 30° C., preferably 22 to 28° C. and normal pressure is preferably standard atmospheric pressure or ±15% range around standard atmospheric pressure.

The content of the solvent (C) is preferably 0 to 99.0 mass %; more preferably 50 to 99.9 mass %; more preferably 75 to 99.5 mass %; further preferably 80 to 99 mass %; further more preferably 90 to 99 mass %, based on the substrate cleaning composition.

It is also a preferred embodiment of the present invention that the solvent (C) is not contained.

### <Other Additive (D)>

The substrate cleaning composition of the present invention can further comprise an other additive (D) excluding components (A) to (C). The other additive (D) comprises a surfactant, an acid, a base, an antibacterial agent, a germicide, an antiseptic or an antifungal agent, and it can comprise any combination of any of these. In a preferred embodiment, the component (D) comprises a surfactant.

In one embodiment of the present invention, the content of the component (D) (in the case of plural, the sum thereof) is 0 to 100 mass % (preferably 0 to 10 mass %; more preferably 0 to 5 mass %; further preferably 0 to 3 mass %; further more preferably 0 to 1 mass %) based on the component (A). It is also one of the preferred embodiments of the present invention that the substrate cleaning composition does not contain component (D) (0 mass %).

### <Remover>

As described above, the substrate cleaning composition of the present invention is applied on a substrate to form a film. Then, the film is removed from the substrate by a remover. The film is capable of holding particles present on the substrate, and it is a preferred embodiment of the present invention that the film is removed by the remover while holding particles.

The remover can be alkaline, neutral or acidic, but is preferably neutral. In one embodiment of the present invention, the pH of the remover is 6 to 8; preferably 6.5 to 7.5; more preferably 6.8 to 7.2; further preferably 6.9 to 7.1. One preferred embodiment of the remover is water. The remover may dissolve carbon dioxide gas. In one preferred embodiment, the remover is a carbonated water in which CO₂ is dissolved, and preferably has a resistivity of 0.1 to 5.0 MΩ·cm.

The measurement of pH is preferably carried out after being degassed, to avoid the influence of the dissolution of carbon dioxide gas in the air. Although not to be bound by theory, since the film formed from the substrate cleaning composition of the present invention can be removed with the above-mentioned remover, for example, when cleaning a substrate that is going to be damaged by a highly alkaline solution, it is possible to reduce the amount of damage received.

Although there is no intention to limit the present invention and not to be bound by theory, a state of cleaning the substrate according to the present invention is described using a schematic FIGURE for the understanding of the present invention.

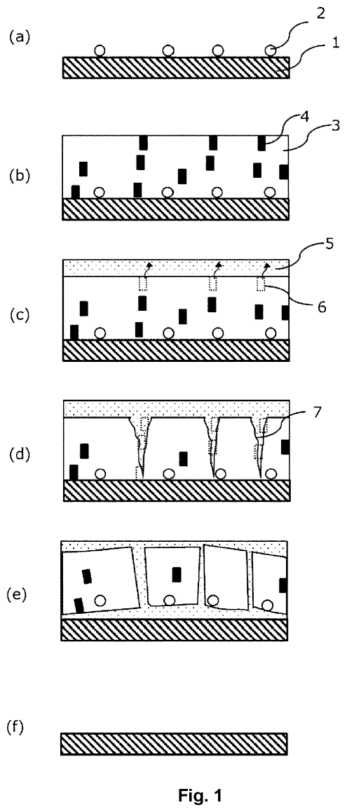

The substrate cleaning composition used in the embodiment of FIG. 1 comprises an insoluble or hardly soluble solute (A), a soluble solute (B) and a solvent (C). (a) shows a state in which particles 2 are attached to the substrate 1. The state in which the substrate cleaning composition of the present invention is dripped on this substrate, dried to remove at least a part of the solvent (C), and the component (A) and component (B) form a film is shown by (b). In (b), the film becomes a particle holding layer 3. The component (B) is present in the particle holding layer 3. Thereafter, the state in which the remover 5 is applied on the film and the component (B) has dissolved in the remover 5 is shown by (c). Through such a dissolvement, traces 6 due to the elution of the component (B) in the particle holding layer 3 are generated. The state in which the cracks 7 spread from the traces 6 as a starting point is shown by (d). The state in which the film parted by the spread of the cracks 7 is removed from the substrate while holding particles is shown by (e). The state of the substrate obtained by being cleaned is shown by (f).

### <Method for Cleaning a Substrate>

The substrate cleaning composition of the present invention can be used to clean a substrate. For the cleaning of a substrate, a known method or an apparatus can be used. The present invention provides a method for manufacturing a cleaned substrate as one embodiment.

In the following, the method for cleaning a substrate is described below using a more particular embodiment. In the following, numbers in parentheses indicate the order of steps. For example, when the steps (1), (2) and (3) are described, the order of the steps is as described above.

The method for manufacturing a cleaned substrate according to the present invention comprises the following steps:
(1) applying the substrate cleaning composition according to the present invention on a substrate;
(2) forming a film from the substrate cleaning composition;
(3) making the film hold particles on the substrate; and
(4) applying a remover on the substrate to remove the film in which particles are held.

In the step (1), in a preferred embodiment, the substrate cleaning composition can be dripped approximately at the center of the substrate in a horizontal position using a nozzle or the like in an apparatus suitable for substrate cleaning. By rotating the substrate at, for example, 10 to several tens of rpm, the generation of dripping traces can be suppressed. The dripping amount is preferably 0.5 to 10 cc. These conditions can be adjusted so that the substrate cleaning composition is uniformly applied and spreads.

In another embodiment, a solid-state composition can be spread over the substrate. In this case, a scraper, roller or the like can be used.

Before applying the step (1), the substrate surface can be subjected to hydrophobic treatment.

The step (2) is preferably performed by spin-drying or heating the substrate.

When the composition according to the present invention contains a solvent (C), the removal of the solvent (C) is carried out by drying, preferably by spin-drying. Spin-drying is preferably performed at 500 to 3,000 rpm (more preferably 500 to 1,500 rpm; further preferably 500 to 1,000 rpm), for preferably 0.5 to 90 seconds (more preferably 5 to 80 seconds; further preferably 15 to 70 seconds; further more preferably 30 to 60 seconds). This allows the solvent (C) to be dried while spreading the substrate cleaning composition over the entire surface of the substrate.

When the composition according to the present invention does not contain the solvent (C), the substrate cleaning composition can be dissolved by heating to form a film. This heating is preferably performed at 250 to 450° C. (more preferably 250 to 350° C.) and preferably for 0.5 to 10 seconds (more preferably 0.5 to 5 seconds; further preferably 1 to 5 seconds).

Preferably, the substrate is a disk shape substrate having a diameter of 200 to 600 mm (more preferably 200 to 400 mm).

The holding of particles in the step (3) is performed by forming a film of the component (A). That is, it can be thought that the steps (2) and (3) occur continuously by one operation. When the substrate cleaning composition according to the present invention contains the solvent (C), a state in which a small amount of the solvent (C) remains in the film is accepted. In one embodiment of the present invention, at the end of the steps (2) and (3), 95% or more (preferably 98% or more; more preferably 99% or more) of the solvent (C) is volatilized and does not remain in the film.

In the steps (2) and/or (3), the temperature within the apparatus can be increased. By the temperature increase, it can be expected that the volatilization of the solvent (C) and the formation of a film of solid components such as the component (A) are promoted. When the temperature is increased, it is preferably 40 to 150° C.

In the step (4), a remover is applied on the substrate to remove the film in which particles are held (particles holding layer). The application can be performed by dripping, spraying, or dipping. The dripping can be performed so as to form a liquid pool (paddle) on the substrate or can be continuously performed. In one embodiment of the present invention, the remover is dripped at the center of the substrate while the substrate is rotating at 500 to 800 rpm.

It is a preferred embodiment of the present invention that the particle holding layer is removed from the substrate while holding particles without being completely dissolved by the remover. In a preferred embodiment, the particle holding layer is removed by, for example, becoming in a state of being finely cut by the “part that triggers peeling off”.

Although not to be bound by theory, it can be thought that in the substrate cleaning composition of the present invention, due to the film formation of the component (A), the force to draw the remover to the interface between the film and the substrate is strong so that the film in which particles are held can be removed more efficiently. It can be thought that when the component (A) that is film-formed has the above-mentioned pKa, pKb or polar group as its characteristics, the force that draws the remover is strengthened. Although not to be bound by theory, it can be thought that when the substrate surface is hydrophilic, the hydrophobic-hydrophobic interaction at the interface between the film and the substrate is not very strong, but when the substrate surface is hydrophobic, this hydrophobic-hydrophobic interaction is strong, so that this makes it difficult for the remover to enter the interface. As mentioned above, when the substrate cleaning composition of the present invention is used, it can be thought that even if the substrate surface is hydrophobic, the remover can be efficiently drawn into the interface and the film in which particles are held can be removed.

As the method for cleaning a substrate according to the present invention, the embodiment that further comprises at least one step other than the above-mentioned is also preferred. Such steps include those known in the cleaning of substrates. For example, the following steps can be mentioned.
(0-1) processing the substrate by etching to form a pattern and removing an etching mask;
(0-2) cleaning the substrate;
(0-3) prewetting the substrate;
(0-4) cleaning the substrate;
(5) dripping water, an aqueous alkaline solution or an organic solvent on the substrate from which the film in which particles are held has been removed, and removing water, the aqueous alkaline solution or the organic solvent to clean the substrate further.

In the step (0-1), the substrate to be cleaned can be a non-processed substrate, and the processing can be performed by lithography technology.

In the step (0-2), the substrate can be cleaned with a known cleaning liquid (rinse liquid, etc.) in order to reduce the number of particles on the substrate. To remove the few particles that remain even after this is one of the objects of the present invention.

The prewetting in the step (0-3) can be performed in order to improve the coatability of the substrate cleaning composition of the present invention and spread it uniformly on the substrate. Preferably, the liquid used for prewetting (prewetting liquid) includes IPA, PGME, PGMEA, PGEE, n-butanol (nBA), pure water and any combination of any of these.

The step (0-4) can be performed to replace the prewetting liquid in the step (0-3). It is also one embodiment of the present invention to make the step (0-4) unnecessary by adding the step (0-2).

In the step (5), it is also a preferred embodiment to further clean the substrate with water, an aqueous alkaline solution or an organic solvent in order to remove local film residues and particle residues. As the cleaning liquid, preferably IPA or an alkaline aqueous solution, more preferably an alkaline aqueous solution, further preferably a TMAH aqueous solution is used. Although not to be bound by theory, since the substrate can be further cleaned without using an organic solvent in the step (5), the substrate cleaning composition of the present invention can reduce the amount of the organic solvent used in the entire process, which is advantageous from a safety point of view.

### <Substrate>

The substrate to be cleaned in the present invention include semiconductor wafers, glass substrates for liquid crystal display, glass substrates for organic EL display, glass substrates for plasma display, substrates for optical disk, substrates for magnetic disk, substrates for magneto-optical disk, glass substrates for photomask, substrates for solar cell, and the like. The substrate may be a non-processed substrate (for example, a bare wafer) or a processed substrate (for example, a patterned substrate). The substrate may be composed by laminating a plurality of layers. Preferably, the surface of the substrate is a semiconductor. The semiconductor may be composed of oxide, nitride, metal, and any combination of any of these. Further, the surface of the substrate is preferably selected from the group consisting of Si, Ge, SiGe, Si₃N₄, TaN, SiO₂, TiO₂, Al₂O₃, SiON, HfO₂, T₂O₅, HfSiO₄, Y₂O₃, GaN, TiN, SiCN, NbN, Cu, Ta, W, Hf, Ru, Co amorphous carbon and Al, more preferably selected from the group consisting of Si, TiO₂, SiON, TiN, SiCN, Cu, W, Ru and Co.

### <Device>

A device can be manufactured by further processing the substrate manufactured by the cleaning method according to the present invention. Examples of the device include semiconductor devices, liquid crystal display devices, organic EL display devices, plasma display devices, and solar cell devices. A known method can be used for processing these.

The present invention is described below with reference to examples. The embodiment of the present invention is not limited only to these examples.

### <Preparation of Cleaning Liquid Composition of Example 1>

Phloroglucinol resin (Mw: 250) as the component (A) and polyacrylic acid (Mw: 5,000) as the component (B) are used. The components (A) and (B) are added to PGME, which is the solvent (C), so that the solid components (sum of the components (A) and (B)) in the composition becomes 10 mass %. The mass ratios of (A) and (B) are as shown in Table 1. That is, in the composition of Example 1, the component (B) is added in a ratio of 5 mass parts to 100 mass parts of the component (A). This is stirred for 1 hour using a stirring bar to obtain a composition having a solid component concentration of 10 mass %. This composition is filtered through Optimizer UPE (Nippon Entegris, UPE, pore size: 10 nm). Thereby, the cleaning liquid composition of Example 1 is obtained.

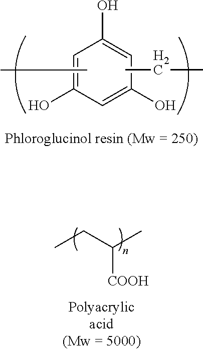

### <Preparation of Cleaning Liquid Compositions of Examples 2 to 20 and Comparative Examples 1 to 7>

Each cleaning liquid composition is prepared in the same manner as in the preparation of the cleaning liquid composition of Example 1, except that the components (A) and (B), the solvent and the blending amount are changed as shown in Tables 1 and 2, respectively. When the solvent composes two types thereof, the mixing ratios (based on mass) are indicated in the table.

TABLE 1

| | | | | | | | | Amounts of | | |
|---|---|---|---|---|---|---|---|---|---|---|
| | | | | | | | Solid | residual particles | | |
| | | | | | | | component | hydro- | hydro- | Suitability |
| | | | (A) | | (B) | | concen- | philic | phobic | for both |
| | | Component (A) | Solubility | Component (B) | Solubility | Solvent | tration | substrate | substrate | substrates |
| Example | 1 | Phloroglucinol | Y | Polyacrylic | Z | PGME | 10% | AA | AA | A |
| | | resin | | acid | | | | | | |
| | | (Mw = 250) | | (Mw = 5,000) | | | | | | |
| | | 100 mass parts | | 5 mass parts | | | | | | |
| | 2 | Phloroglucinol | Y | Polyacrylic | Z | PGME | 1% | AA | A | A |
| | | resin | | acid | | | | | | |
| | | (Mw = 250) | | (Mw = 5,000) | | | | | | |
| | | 100 mass parts | | 5 mass parts | | | | | | |
| | 3 | Phloroglucinol | Y | Polyacrylic | Z | PGME | 30% | A | A | A |
| | | resin | | acid | | | | | | |
| | | (Mw = 250) | | (Mw = 5,000) | | | | | | |
| | | 100 mass parts | | 5 mass parts | | | | | | |
| | 4 | Phloroglucinol | Y | Polyacrylic | Z | PGME/DIW | 10% | AA | AA | A |
| | | resin | | acid | | 95:5 | | | | |
| | | (Mw = 250) | | (Mw = 5,000) | | | | | | |
| | | 100 mass parts | | 5 mass parts | | | | | | |
| | 5 | Phloroglucinol | Y | Polyacrylic | Z | PGME/PGMEA | 10% | AA | AA | A |
| | | resin | | acid | | 80:20 | | | | |
| | | (Mw = 250) | | (Mw = 5,000) | | | | | | |
| | | 100 mass parts | | 5 mass parts | | | | | | |
| | 6 | Phloroglucinol | Y | Polyacrylic | Z | IPA | 10% | AA | AA | A |
| | | resin | | acid | | | | | | |
| | | (Mw = 250) | | (Mw = 5,000) | | | | | | |
| | | 100 mass parts | | 5 mass parts | | | | | | |
| | 7 | Phloroglucinol | Y | Polyacrylic | Z | PGME | 10% | AA | AA | A |
| | | resin | | acid | | | | | | |
| | | (Mw = 250) | | (Mw = 5,000) | | | | | | |
| | | 100 mass parts | | 5 mass parts | | | | | | |
| | 8 | Phloroglucinol | Y | Polyacrylic | Z | PGME | 10% | AA | AA | A |
| | | resin | | acid | | | | | | |
| | | (Mw = 1000) | | (Mw = 5,000) | | | | | | |
| | | 100 mass parts | | 5 mass parts | | | | | | |
| | 9 | Phloroglucinol | Y | Polyacrylic | Z | PGME | 10% | AA | AA | A |
| | | resin | | acid | | | | | | |
| | | (Mw = 1000) | | (Mw = 5,000) | | | | | | |
| | | 100 mass parts | | 5 mass parts | | | | | | |
| | 10 | Phloroglucinol | Y | Succinic acid | Z | PGME | 10% | A | A | A |
| | | resin | | 5 mass parts | | | | | | |
| | | (Mw = 250) | | | | | | | | |
| | | 100 mass parts | | | | | | | | |
| | 11 | Phloroglucinol | Y | Phthalic acid | Z | PGME | 10% | A | A | A |
| | | resin | | 5 mass parts | | | | | | |
| | | (Mw = 250) | | | | | | | | |
| | | 100 mass parts | | | | | | | | |
| | 12 | Phloroglucinol | Y | Maleic acid | Z | PGME | 10% | A | A | A |
| | | resin | | 5 mass parts | | | | | | |
| | | (Mw = 250) | | | | | | | | |
| | | 100 mass parts | | | | | | | | |
| | 13 | Phloroglucinol | Y | Ammonium | Z | PGME/DIW | 10% | A | AA | A |
| | | resin | | carbonate | | 60:40 | | | | |
| | | (Mw = 250) | | 5 mass parts | | | | | | |
| | | 100 mass parts | | | | | | | | |
| | 14 | Phloroglucinol | Y | Ammonium | Z | PGME/DIW | 10% | A | AA | A |
| | | resin | | Hydrogen- | | 60:40 | | | | |
| | | (Mw = 250) | | carbonate | | | | | | |
| | | 100 mass parts | | 5 mass parts | | | | | | |
| | 15 | Phloroglucinol | Y | Polyacrylic | Z | PGME | 10% | A | AA | A |
| | | 100 mass parts | | acid | | | | | | |
| | | | | (Mw = 5,000) | | | | | | |
| | | | | 5 mass parts | | | | | | |
| | 16 | Phloroglucinol | Y | Polyacrylic | Z | none | 100% | AA | AA | A |
| | | 100 mass parts | | acid | | | | | | |
| | | | | (Mw = 5,000) | | | | | | |
| | | | | 5 mass parts | | | | | | |
| | 17 | Benzenetriol | Y | Polyacrylic | Z | PGME | 10% | AA | AA | A |
| | | resin | | acid | | | | | | |
| | | (Mw = 250) | | (Mw = 5,000) | | | | | | |
| | | 100 mass parts | | 5 mass parts | | | | | | |
| | 18 | Melamine resin | Y | Diethanolamine | Z | PGME | 10% | AA | AA | A |
| | | (Mw = 250) | | 5 mass parts | | | | | | |
| | | 100 mass parts | | | | | | | | |
| | 19 | Melamine | Y | Diethanolamine | Z | PGME | 10% | AA | AA | A |
| | | 100 mass parts | | 5 mass parts | | | | | | |
| | 20 | Melamine | Y | Diethanolamine | Z | none | 100% | AA | AA | A |
| | | 100 mass parts | | 5 mass parts | | | | | | |

TABLE 2

| | | | | | | | | Amounts of | | |
|---|---|---|---|---|---|---|---|---|---|---|
| | | | | | | | Solid | residual particles | | |
| | | | | | | | component | hydro- | hydro- | Suitability |
| | | | (A) | | (B) | | concen- | philic | phobic | for both |
| | | Component (A) | Solubility | Component (B) | Solubility | Solvent | tration | substrate | substrate | substrates |
| Comparative | 1 | PHS resin | X | Polyacrylic | Z | PGME | 3.0% | AA | C | B |
| Example | | (Mw = 5000) | | acid | | | | | | |
| | | 100 mass parts | | (Mw = 5,000) | | | | | | |
| | | | | 5 mass parts | | | | | | |
| | 2 | Phenol resin | X | Polyacrylic | Z | PGME | 3.0% | AA | C | B |
| | | (Mw = 5000) | | acid | | | | | | |
| | | 100 mass parts | | (Mw = 5,000) | | | | | | |
| | | | | 5 mass parts | | | | | | |
| | 3 | Novolak resin | X | Polyacrylic | Z | PGME | 3.0% | AA | C | B |
| | | (Mw = 5000) | | acid | | | | | | |
| | | 100 mass parts | | (Mw = 5,000) | | | | | | |
| | | | | 5 mass parts | | | | | | |
| | 4 | Polybutyl | X | Polyacrylic | Z | PGME | 3.0% | AA | C | B |
| | | acrylate | | acid | | | | | | |
| | | (Mw = 5000) | | (Mw = 5,000) | | | | | | |
| | | 100 mass parts | | 5 mass parts | | | | | | |
| | 5 | Polycarbonate | X | Polyacrylic | Z | PGME | 3.0% | AA | C | B |
| | | (Mw = 5000) | | acid | | | | | | |
| | | 100 mass parts | | (Mw = 5,000) | | | | | | |
| | | | | 5 mass parts | | | | | | |
| | 6 | Polymethyl | X | Polyacrylic | Z | PGME | 3.0% | AA | C | B |
| | | methacrylate | | acid | | | | | | |
| | | (Mw = 5000) | | (Mw = 5,000) | | | | | | |
| | | 100 mass parts | | 5 mass parts | | | | | | |
| | 7 | Dihydroxytetra- | Y | Polyacrylic | Z | PGME | 3.0% | AA | C | B |
| | | phenylmethan | | acid | | | | | | |
| | | 100 mass parts | | (Mw = 5,000) | | | | | | |
| | | | | 5 mass parts | | | | | | |

### In Tables 1 and 2:

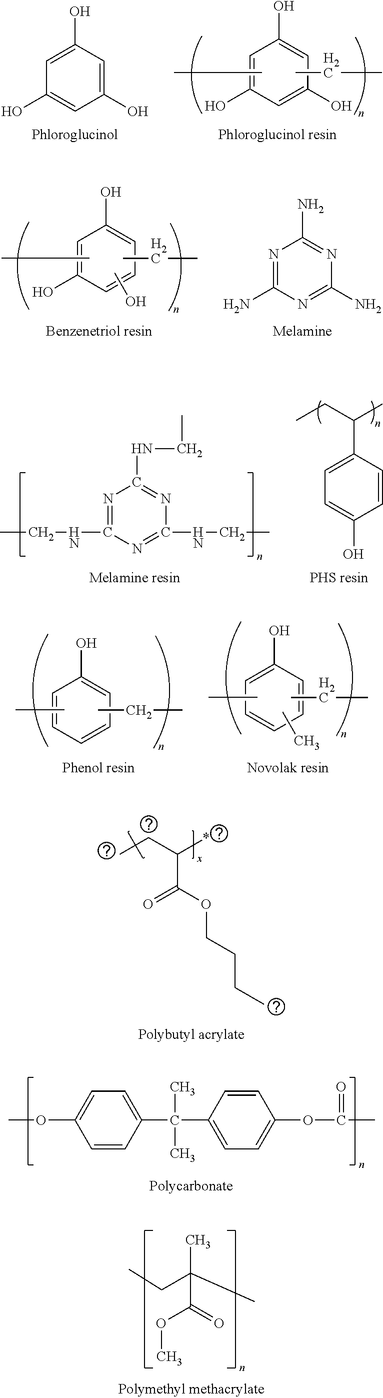

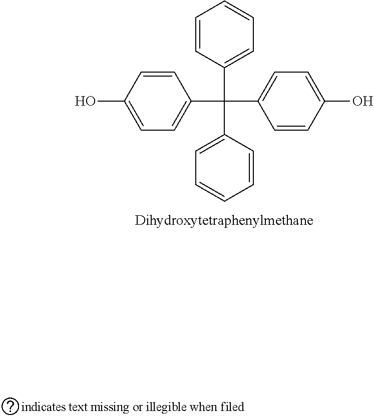 [SMILES: Oc1ccc(C(c2ccccc2)(c2ccccc2)c2ccc(O)cc2)cc1]

### <Evaluation of Solubility>

4 mg of each component to be used is put in a 50 mL sample bottle, and DIW is added to make the total amount to be 40 g. Covering this with a cap, it is shaken and stirred for 1 hour. This gives an aqueous solution having a component concentration of 100 ppm.

The same procedure as described above is carried out except that the amounts of each component added are changed, and aqueous solutions having a component concentration of 3,000 ppm are obtained.

Their solubility is checked visually. Evaluation criteria are as shown below. The evaluation results are shown in Tables 1 and 2.

X: When the dissolution residue is confirmed at 100 ppm, it is judged to be insoluble.

Y: When the dissolution residue is not confirmed at 100 ppm but confirmed at 3,000 ppm, it is judged to be hardly soluble.

Z: When the dissolution residue is not confirmed at 3,000 ppm, it is judged to be soluble.

### <Preparation of Substrate for Particle Removal Evaluation>

An 8-inch bare silicon substrate (SUMCO) is used as the hydrophilic substrate.

As the hydrophobic substrate, an 8-inch bare silicon substrate (SUMCO) on which a 5,000 nm SiCN film is formed by plasma CVD treatment is used.

Particles are attached to the hydrophilic substrate and the hydrophobic substrate. Ultra-high purity colloidal silica (PL-10H, Fuso Chemical Industry, average primary particle size: 90 nm) is used as particles for experiment. 50 mL of the silica fine particle composition is dripped and applied by rotating at 500 rpm for 5 seconds. Thereafter, the solvent of the silica fine particle composition is spin-dried by rotating at 1,000 rpm for 30 seconds. Thereby, a substrate for particle removal evaluation is obtained.

### <Particle Removal Evaluation>

When using the cleaning compositions other than Examples 16 and 20, Coater/Developer RF³ (SOKUDO) is used, 10 cc of each cleaning solution is dripped on each substrate for particle removal evaluation, and coating and drying are performed by rotating at 1,500 rpm for 60 seconds to form a film.

When using the cleaning compositions of Examples 16 and 20, the cleaning composition is spread on the substrate for particle removal evaluation so that it becomes flat, and then the wafer is heated at 350° C. for 3 seconds to melt and form a film.

While rotating at 100 rpm the substrate on which a film is formed, water (deionized water) that is a remover is dripped for 10 seconds, the whole substrate is covered with water, after this state is maintained for 60 seconds, by rotating the substrate at 1,500 rpm, the film is peeled off and removed, and the substrate is dried.

The amounts of residual particles on these substrates are counted using a dark field defect inspection system (LS-9110, Hitachi High-Technologies) and evaluated according to the following criteria. The evaluation results are shown in Tables 1 and 2.

$$AA : \underline{<} 10 pieces$$

$$A : > 10 pieces , \underline{<} 100 pieces$$

$$B : > 100 pieces , \underline{<} 1 , 000 pieces$$

$$C : 1 , 000 pieces$$

D: film is not uniformly coated, or film is not removed

### <Suitability for Both Substrates>

Suitability for both substrates is evaluated according to the following criteria. The evaluation results are shown in Tables 1 and 2.

A: Particle removal evaluation is AA or A for both hydrophilic substrate and hydrophobic substrate.

B: Particle removal evaluation is AA or A for one of hydrophilic substrate or hydrophobic substrate, but B or C for the other.

C: Particle removal evaluation is B or C for both hydrophilic substrate and hydrophobic substrate.

### EXPLANATION OF SYMBOLS

1. substrate
2. particle
3. particle holding layer
4. soluble solute (B)
5. remover
6. trace due to elution of soluble solute (B)
7. crack

1. A substrate cleaning composition comprising an insoluble or hardly soluble solute (A):
wherein
the insoluble or hardly soluble solute (A) is a monomer of (A-1) and/or a multimer of (A-1);
the pKa of the insoluble or hardly soluble solute (A) is 9.5 to 4, the pKb of the insoluble or hardly soluble solute (A) is 9.5 to 4, and/or (A-1) comprises 2 to 4 polar groups; and
the polar group is at least one selected from the group consisting of —OH, —COOH, —NO₂, —NH₂ and —NH—:
optionally, the substrate cleaning composition comprises a solvent (C);
optionally, the substrate cleaning composition is applied on a substrate and dried to remove at least a part of the solvent (C) to form a film, the film being then removed from the substrate by a remover;
optionally, the substrate cleaning composition is applied on a substrate and heated to form a film, the film being then removed from the substrate by the remover; and/or
optionally, the insoluble or hardly soluble solute (A) is insoluble or hardly soluble by the remover.

2. The substrate cleaning composition according to claim 1, wherein (A-1) is represented by the formula (a-1): 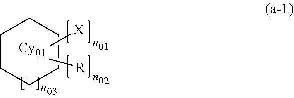
where
Cy₀₁ is an unsaturated hydrocarbon ring, and optionally 1 to 3 of the C constituting Cy₀₁ can be each independently replaced with N, S or O;
X is each independently —OH, —COOH, —NO₂ or —NR′R″;
R′ and R″ are each independently hydrogen or C₁₋₅ alkyl;
R is each independently C₁₋₁₀ alkyl, —CHO, —C(═O)CH₃, —C(═O)C₂H₅, —CH═CH₂ or —O—C(═O)—CH═CH₂; and
n₀₁ is 0 to 4, n₀₂ is 0 to 3, and n₀₃ is 0 to 1, provided that 0≤(n₀₁+n₀₂)≤(5+n₀₃) is satisfied.

3. The substrate cleaning composition according to claim 1, further comprising a soluble solute (B):
optionally, the soluble solute (B) is soluble by the remover;
optionally, the content of the insoluble or hardly soluble solute (A) is 1.0 to 100 mass % based on the substrate cleaning composition;
optionally, the content of the solvent (C) is 0 to 99.0 mass % based on the substrate cleaning composition; and/or
optionally, the content of soluble solute (B) is 0 to 50 mass % based on the substrate cleaning composition.

4. The substrate cleaning composition according to claim 1, wherein the solvent (C) comprises water (C-1):
optionally, the content of water (C-1) is 0.1 to 10 mass % based on the solvent (C).

5. The substrate cleaning composition according to claim 2, wherein the multimer of (A-1) comprises a repeating unit represented by the formula (a-1-1) or a repeating unit represented by the formula (a-1-2): 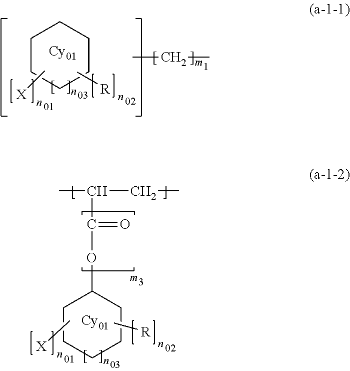
where
Cy₀₁, X, R, n₀₁, n₀₂ and n₀₃ are as described in claim 2;
m₁ is a number of 1 or more, m₃ is 0 to 1;
in the formula (a-1-1), the hydrogen atom in X or the hydrogen atom directly connected to the ring is removed and connected to —CH₂—;
optionally, when the insoluble or hardly soluble solute (A) comprises the multimer of (A-1), a repeating unit represented by a structure other than the formula (a-1-1) or formula (a-1-2) can be contained; and/or
optionally, when the insoluble or hardly soluble solute (A) is a multimer of (A-1), the Mw thereof is 250 to 50,000.

6. The substrate cleaning composition according to claim 3, wherein the soluble solute (B) comprises a repeating unit represented by the formula (b-1): 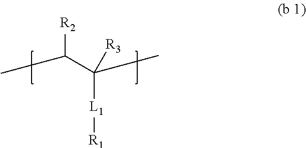
where
L₁ is selected from the group consisting of a single bond, C₁₋₄ alkylene, phenylene, ether, carbonyl, amide and imide;
R₁ is carboxy, sulfo or phospho;
R₂ is hydrogen, methyl or carboxyl; and
R₃ is hydrogen or methyl:
optionally, the acid dissociation constant pKa (H₂O) of the soluble solute (B) is −5 to 11; and/or
optionally, the molecular weight of the soluble solute (B) is 500 to 500,000.

7. The substrate cleaning composition according to claim 1, wherein the solvent (C) further comprises an organic solvent (C-2).

8. The substrate cleaning composition according to claim 3, wherein the solubility of the insoluble or hardly soluble solute (A) in water is 3,000 ppm or less, and the solubility of the soluble solute (B) in water is more than 3,000 ppm:
optionally, the solubility is determined under the conditions of 20 to 35° C. by providing a flask charged with 3,000 ppm of the above (A) or (B) in water, covering the flask with a cap, shaking for 1 hour in a shaker, and confirming whether (A) or (B) is dissolved or not.

9. The substrate cleaning composition according to claim 1, further comprising an other additive (D), wherein the other additive (D) comprises a surfactant, an acid, a base, an antibacterial agent, a germicide, an antiseptic or an antifungal agent:
optionally, the content of the other additive (D) is 0 to 100 mass % based on the insoluble or hardly soluble solute (A).

10. A method for manufacturing a cleaned substrate comprising the following steps:
(1) applying the substrate cleaning composition according to claim 1 on a substrate;
(2) forming a film from the substrate cleaning composition;
(3) making the film hold particles on the substrate; and
(4) applying a remover on the substrate to remove the film in which particles are held.

11. The method for manufacturing a cleaned substrate according to claim 10, wherein the step (2) is carried out by spin-drying or heating the substrate:
optionally, the spin-drying is carried out at 500 to 3,000 rpm for 0.5 to 90 seconds;
optionally, removing at least a part of the solvent (C) in the substrate cleaning composition by the spin-drying to form a film from the composition;
optionally, the substrate is a disk shape substrate and has a diameter of 200 to 600 mm;
and/or optionally, the heating is carried out at 250 to 450° C. for 0.5 to 10 seconds.

12. The method for manufacturing a cleaned substrate according to claim 10, wherein the substrate in (1) is a non-processed substrate or processed substrate:
optionally, the surface of the substrate is a semiconductor;
optionally, prior to application of the substrate cleaning composition, the surface of the substrate is hydrophobically treated; and/or
optionally, the surface of the substrate is selected from the group consisting of Si, Ge, SiGe, Si₃N₄, TaN, SiO₂, TiO₂, Al₂O₃, SiON, HfO₂, Ta₂O₅, HfSiO₄, Y₂O₃, GaN, TiN, SiCN, NbN, Cu, Ta, W, Hf, Al, Ru, Co and amorphous carbon.

13. The method for manufacturing a cleaned substrate according to claim 10, further comprising at least one of the following steps:
(0-1) processing the substrate by etching to form a pattern and removing an etching mask;
(0-2) cleaning the substrate;
(0-3) prewetting the substrate;
(0-4) cleaning the substrate;
(5) dripping water, an aqueous alkaline solution or an organic solvent on the substrate from which the film in which particles are held has been removed, and removing water, the aqueous alkaline solution or the organic solvent to clean the substrate further.

14. A method for manufacturing a device, comprising the method for manufacturing a cleaned substrate according to claim 10.

15. The substrate cleaning composition according to claim 2, further comprising a soluble solute (B):
optionally, the soluble solute (B) is soluble by the remover;
optionally, the content of the insoluble or hardly soluble solute (A) is 1.0 to 100 mass % based on the substrate cleaning composition;
optionally, the content of the solvent (C) is 0 to 99.0 mass % based on the substrate cleaning composition; and/or
optionally, the content of soluble solute (B) is 0 to 50 mass % based on the substrate cleaning composition.

16. A method for manufacturing a cleaned substrate comprising the following steps:
(1) applying the substrate cleaning composition according to claim 5 on a substrate;
(2) forming a film from the substrate cleaning composition;
(3) making the film hold particles on the substrate; and
(4) applying a remover on the substrate to remove the film in which particles are held.

17. A method for manufacturing a cleaned substrate comprising the following steps:
(1) applying the substrate cleaning composition according to claim 6 on a substrate;
(2) forming a film from the substrate cleaning composition;
(3) making the film hold particles on the substrate; and
(4) applying a remover on the substrate to remove the film in which particles are held.
